(19) United States
(12) Patent Application Publication
(10) Pub. No.: US 2025/0260084 A1
(43) Pub. Date: Aug. 14, 2025

(54) INCOMPATIBLE BATTERY COOLING FLUID DETECTION SYSTEM

(71) Applicants: DEERE & COMPANY, Moline, IL (US); JOHN DEERE ELECTRIC POWERTRAIN LLC, Moline, IL (US)

(72) Inventors: Thomas L. Kennedy, Bettendorf, IA (US); Norbert Heublein, Kefermarkt (AT); Anna Theresia Stadler, Rainbach i.M. Mühlkreis (AT)

(21) Appl. No.: 18/440,514

(22) Filed: Feb. 13, 2024

(51) Int. Cl. H01M 10/633; B60K 11/02; H01M 10/613; H01M 10/625; H01M 10/6568

(52) U.S. Cl. CPC H01M 10/633; H01M 10/613; H01M 10/625; H01M 10/6568; B60K 11/02; H01M 2220/20

(57) ABSTRACT

An immersion cooling system for a battery of an electric vehicle. The immersion cooling system includes an incompatible fluid detection system configured to detect a presence of an incompatible fluid within a fluid circuit of the immersion cooling system. The incompatible fluid can include a non-dielectric fluid that has entered or accumulated within the fluid circuit, as well as a dielectric fluid that has been contaminated or is reaching, if not already attained, an end-of-life for the dielectric fluid. In response to a determination of a presence of the incompatible fluid in the fluid circuit, a notification can be generated to alert an operator of the detection of the incompatible fluid. Additionally, the system can take actions, including closing a valve(s), deactivating a pump, and/or opening a bypass circuit(s), among other actions, to isolate at least the battery from the incompatible fluid.

### FIELD OF THE DISCLOSURE

The present disclosure generally relates to immersion liquid cooling of batteries, and, more specifically, to a system for detection of an incompatible fluid in at least a portion of an immersion liquid cooling system for one or more batteries of an electric vehicle.

### BACKGROUND

Battery systems of electric vehicles, including hybrid electric vehicles, can utilize both active heating and cooling systems that assist with one or more batteries of the electric vehicle being, at, or around, certain operating temperatures. Such heating and cooling systems can assist with the battery(ies) of the electric vehicle being maintained at temperatures at which the battery(ies) can be charged, as well as discharged, at certain current levels, including be discharged at current levels that can support or satisfy various functions of the electric vehicle.

One manner of transferring heat from batteries is immersion cooling. With immersion cooling, including partial immersion cooling and full immersion cooling, battery cells of the battery can come into direct contact with a cooling liquid. Accordingly, the cooling liquid utilized with immersion cooling is typically an electrically non-conductive liquid, also referred to as a dielectric cooling liquid. Such dielectric cooling liquids can be, or can include an oil whose viscosity can change with changes in temperature of the dielectric cooling liquid.

### SUMMARY

The present disclosure may comprise one or more of the following features and combinations thereof.

In one embodiment of the present disclosure, an immersion cooling system for cooling a battery and having an incompatible fluid detection system is provided. The immersion cooling system can include a fluid circuit configured to circulate a cooling liquid to the battery, and a plurality of sensors configured to sense one or more properties of at least the cooling liquid, at least one processor, a first sensor of the plurality of sensors positioned within a cooling liquid reservoir of the immersion cooling system. The immersion cooling system can further include a memory device coupled to the at least one processor. The memory device can include instructions that when executed by the at least one processor can cause one or more of the at least one processor to determine, based on at least information provided by the plurality of sensors, a presence of an incompatible fluid in the fluid circuit, and generate, in response to the determination of the presence of the incompatible fluid, one or more signals to facilitate an adjustment of a flow path of the incompatible fluid within the fluid circuit to isolate the battery from the incompatible fluid.

In another embodiment, an immersion cooling system for cooling a battery and having an incompatible fluid detection system is provided. The immersion cooling system can include a fluid circuit configured to circulate a cooling liquid to the battery, at least one processor, and a memory device coupled to the at least one processor. The memory device can include instructions that when executed by the at least one processor can cause one or more of the at least one processor to determine a presence of an incompatible fluid in the fluid circuit, and generate, in response to the determination of the presence of the incompatible fluid, one or more signals to facilitate an adjustment of a flow path of the incompatible fluid within the fluid circuit to isolate the battery from the incompatible fluid.

In a further embodiment of the present disclosure, a method is provided for detecting a presence of an incompatible fluid within a fluid circuit of an immersion cooling system for a battery of an electric vehicle. The method can include monitoring, by a plurality of sensors, one or more properties of a fluid within the fluid circuit, at least one of the plurality of sensors being positioned within a cooling liquid reservoir of the immersion cooling system. The method can also include detecting, using at least information from the monitored one or more properties, at least a portion of the fluid in the fluid circuit comprises an incompatible fluid. The method can also include generating, in response to the detection of the incompatible fluid, one or more signals to facilitate an adjustment of a flow path of at least the incompatible fluid within the fluid circuit to isolate the battery from the incompatible fluid.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a simplified block diagram of a first embodiment of at least a portion of an exemplary incompatible fluid detection system of an immersion cooling system for one or more batteries of an electric vehicle.

FIG. 2 illustrates a simplified block diagram of a second embodiment of at least a portion of an exemplary incompatible fluid detection system of an immersion cooling system for one or more batteries of an electric vehicle.

FIG. 3 illustrates a simplified block diagram of a third embodiment of at least a portion of an exemplary incompatible fluid detection system of an immersion cooling system for one or more batteries of an electric vehicle.

FIG. 4 illustrates a simplified block diagram of a fourth embodiment of at least a portion of an exemplary incompatible fluid detection system of an immersion cooling system for one or more batteries of an electric vehicle.

FIG. 5 illustrates an exemplary method for operating an incompatible fluid detection system for one or more immersion cooled batteries of an electric vehicle.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A number of features described below may be illustrated in the drawings in phantom. Depiction of certain features in phantom is intended to convey that those features may be hidden or present in one or more embodiments, while not necessarily present in other embodiments. Additionally, in the one or more embodiments in which those features may be present, illustration of the features in phantom is intended to convey that the features may have location(s) and/or position(s) different from the locations(s) and/or position(s) shown.

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

Embodiments of the subject disclosure generally relate to an incompatible fluid detection system of an immersion cooling system for one or more batteries of an electric vehicle. The system can be configured to detect, including identify, the presence of an incompatible fluid in a fluid circuit, including detecting an incompatible fluid in, or comprising, a cooling liquid that is in at least a portion of the fluid circuit. A determination of whether a cooling liquid is, or contains, an incompatible fluid can be based on one or more properties, conditions, or characteristics of at least a portion of the cooling liquid within the fluid circuit. For example, according to certain embodiments, an incompatible fluid can correspond to a presence of a non-dielectric cooling liquid in a least a portion of the cooling liquid in the fluid circuit, including, for example, mixed or otherwise present in at least a portion of a dielectric cooling liquid. Additionally, or alternatively, the detected incompatible fluid can correspond to a dielectric cooling liquid that has degraded and/or been contaminated, including, for example, via leaching of a chemical(s) from components of the fluid circuit into the dielectric cooling liquid or other dispersions. Moreover, such derogation or contamination of the dielectric cooling liquid in the fluid circuit can correspond to a deterioration or adverse impact on one or more properties of the dielectric cooling liquid that can be adverse to, for example, the electrical conductivity or heat transfer properties of the dielectric cooling liquid, among other properties Further, information regarding one or more such properties of the dielectric cooling liquid can provide an information regarding whether the dielectric cooling liquid is approaching, and/or has reached, an end-of-life with respect to the effectiveness, usefulness, and/or safe use of the dielectric cooling liquid for immersion cooling of one or more batteries of the immersion cooling system. Such information provided regarding one or more properties of the cooling liquid can further be analyzed on-line or off-line, including, for example, with respect to the deterioration of the cooling liquid over time, premature aging of the cooling liquid, performance of an associated thermal management system, or combinations thereof, among other analysis.

Another aspect of the incompatible fluid detection system is generation of a notification, including an alert, in response to the detection of the incompatible fluid in the fluid circuit. The generated notification can be communicated by an output device of the electric vehicle and/or to a battery management system (BMS). Additionally, or alternatively, the generated notification can be communicated by an output device of a secondary device, including, for example, a secondary device that is remote from the electric vehicle. Such a notification can be communicated in a variety of manners, including, for example, via visually, audibly, and/or via a haptic device, as well as any combinations thereof.

The incompatible fluid detection system can also be configured for one or more actions to be taken in response to the detection of the incompatible fluid in the fluid circuit. According to certain embodiments, one or more of the actions can automatically occur in response to the detection of the incompatible fluid. Additionally, or alternatively, one or more actions may be taken by and operator, including, for example, and owner, service personnel, or user of/for the electric vehicle, among other individuals or workers (generally referred to herein as “operator”), in response to receipt of the above-mentioned generated notification. As discussed below, such actions can include actions that isolates, including, for example, bypasses a flow of the incompatible fluid, from the battery(ies). Additionally, or alternatively, one or more actions can relate to purging or discharging the incompatible fluid from the fluid circuit.

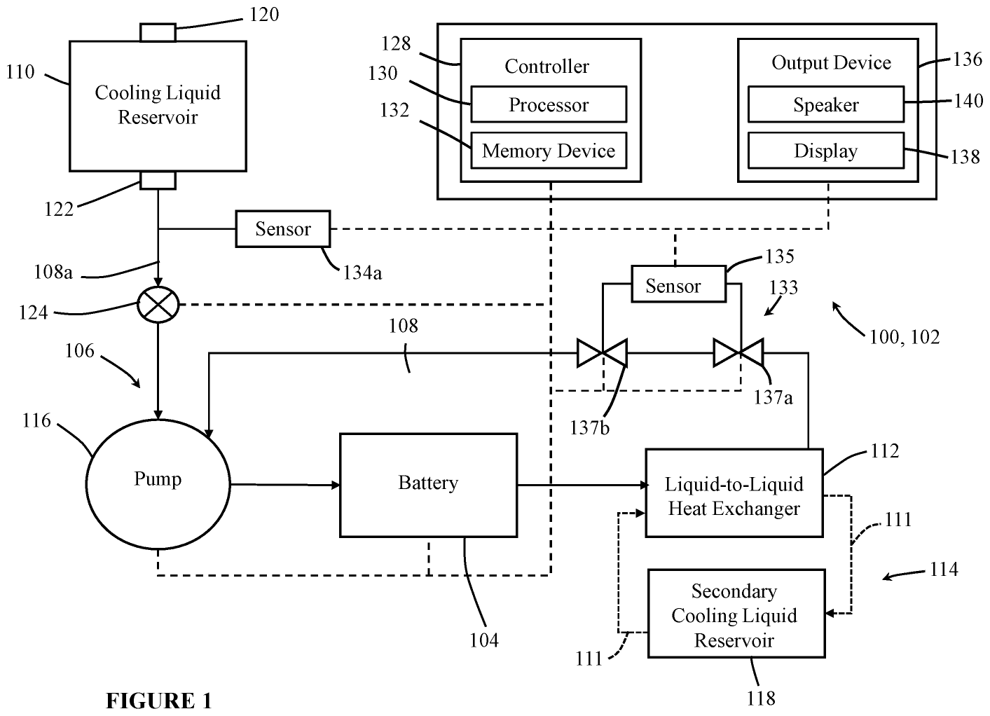

FIG. 1 illustrates a simplified block diagram of a first embodiment of at least a portion of an exemplary incompatible fluid detection system 100 for an immersion cooling system 102. The immersion cooling system 102 can be configured to at least cool, via immersion cooling, one or more batteries 104 of an electric vehicle. Further, the illustrated immersion cooling system 102 is configured for a cooling liquid in the form of a dielectric cooling liquid to circulate between components or devices of a fluid circuit 106 of the immersion cooling system 102 through one or more conduits 108, including tubes, hoses, or pipes, and/or combinations thereof, as well as any associated fittings and couplings. A variety of different types of dielectric cooling liquids can be circulated about the fluid circuit 106 as the cooling liquid, including, but not limited to, mineral oil, as well as various commercially available dielectric thermal fluids, among other dielectric cooling liquids. Further, the immersion cooling system 102 can be configured for partial or full immersion liquid cooling of one or more battery cells of the battery 104.

As seen in FIG. 1, the immersion cooling system 102 can, at various locations about the fluid circuit 106, include a cooling liquid reservoir 110 for the dielectric cooling liquid, a pump 116, the battery 104, and the associated conduits 108 and fittings. However, the immersion cooling system 102 can include a variety of other components or devices in addition to those shown and discussed herein, including, but not limited to, heaters, radiators, filters, control valves, and/or relief vales, as well as combinations thereof, among other components of immersion cooling systems utilized with batteries of at least electric vehicles.

In the illustrated embodiment, the immersion cooling system 102 is shown as including a heat exchanger 112 that is fluidly coupled to both the fluid circuit 106 and a secondary circuit 114 of the immersion cooling system 102. While the immersion cooling system 102 can include one or more heat exchangers positioned at various locations about the fluid circuit 106, as well as different types of heat exchangers, for at least purposes of discussion, the illustrated heat exchanger 112 is a liquid-to-liquid type heat exchanger. Thus, according to the illustrated embodiment, heat entrained in the cooling liquid, and, more specifically, the dielectric cooling liquid, in the fluid circuit 106 that is outputted from the battery 104 can, at the heat exchanger 112, be transferred to another type of cooling liquid, referred to herein as a secondary cooling liquid, that is circulated through at least one or more conduits 111 of the secondary circuit 114. In the illustrated embodiment, the secondary circuit 114 is shown as including a secondary reservoir 118 that can at least temporarily store an excess of the secondary cooling liquid. However, the secondary circuit 114 can include a variety of other components, including, but not limited to, a pump, control valve, pressure relief valve, and/or filter, as well as combinations thereof, among other components. Additionally, the secondary circuit 114 can be coupled to another heat exchanger, or otherwise be configured to accommodate a release or transfer of at least a portion of the heat that is transferred to the secondary cooling liquid at the heat exchanger 112 so that the secondary cooling liquid is at least received into the heat exchanger 112 at a temperature that can assist in the transfer of heat from the dielectric cooling liquid in the fluid circuit 106 to the secondary cooling liquid at the heat exchanger 112.

According to the illustrated embodiment, the secondary cooling liquid can be a non-dielectric cooling liquid, such as, for example, a glycerol and/or water-based cooling liquid. Thus, in the illustrated embodiment, the fluid circuit 106 and secondary circuit 114 are configured for the secondary cooling liquid of the secondary circuit 114 to not enter the fluid circuit 106, and, moreover, not be circulated to, or through, the battery 104. However, one or more components of the fluid circuit 106 and/or secondary circuit 114, including the heat exchanger 112, hoses or pipes, and/or associated couplings, can potentially fail, be breached, or not properly connected to associated conduits 108, 111 or fittings in a manner that can accommodate at least some non-dielectric secondary cooling liquid entering into the dielectric cooling liquid in the fluid circuit 106, thereby contaminating the dielectric cooling liquid. In such a situation, circulation within the fluid circuit 106 of contaminated cooling liquid that includes both the dielectric cooling liquid and an incompatible fluid in the form of the non-dielectric secondary cooling liquid can result in the incompatible fluid entering into the battery 104 and coming into contact with one or more battery cells. In such an example, as the incompatible fluid present in at least a portion of the cooling liquid is not a dielectric liquid, and, more specifically, is electrically conductive, such contact of the incompatible fluid with one or more battery cells can facilitate a hazardous electrical shorting the battery 104. Such an electrical shorting within the battery 104 can not only damage, if not destroy, the battery 104, but also damage the electric vehicle, including, for example, facilitate the generation of a fire in at least at portion of the electric vehicle. However, as discussed herein, in the event an incompatible fluid such as the non-dielectric secondary cooling liquid enters, or is otherwise introduced, into the dielectric cooling liquid that is circulated about the fluid circuit 106, the incompatible fluid detection system 100 is configured to detect the presence of the incompatible fluid and isolate the incompatible fluid and/or the contaminated cooling liquid from the battery 104. As discussed below, according to certain embodiments, such isolation of the incompatible fluid can, for example, include bypassing a flow of the incompatible fluid such that the incompatible fluid does not flow into the battery 104.

The cooling liquid reservoir 110 can be configured to at least temporarily store dielectric cooling liquid for the fluid circuit 106, including excess cooling liquid. To the extent necessary, the cooling liquid reservoir 110 can assist in replenishing at least a portion of the dielectric cooling liquid that is circulating through at least the conduits 108 of the fluid circuit 106. Additionally, or alternatively, to the extent needed, the cooling liquid reservoir 110 can also provide an outlet for a flow, including an overflow, of the cooling liquid or associated gases that may be at least occasionally present within at least a portion of the immersion cooling fluid circuit 106 as the cooling liquid is heated or overheated.

As seen in FIG. 1, the cooling liquid reservoir 110 can include an inlet 120 and an outlet 122. The outlet 122 can be coupled to a supply conduit 108a or other portion of the fluid circuit 106 such that cooling liquid can flow out of the cooling liquid reservoir 110 and to downstream portions of the fluid circuit 106. The inlet 120 can provide a location at which at least dielectric cooling liquid can be supplied, added, or replenished to/for the cooling liquid of the fluid circuit 106. Thus, for example, an operator of the electric vehicle can introduce or supply dielectric cooling liquid to the fluid circuit 106 through the inlet 120 to the cooling liquid reservoir 110.

The inlet 120 of the cooling liquid reservoir 110 can also provide a location for the introduction of an incompatible fluid, or other containments, into the fluid circuit 106, including into the dielectric cooling liquid. For example, the inlet 120 can provide a location at which an operator can inadvertently introduce a non-dielectric, or electrically conductive, cooling liquid or other incompatible fluid, into the cooling liquid and/or the fluid circuit 106. In one particular, non-limiting example, rather than adding secondary cooling liquid to the cooling liquid reservoir 110 of the secondary circuit 114, an operator can mistakenly add the secondary cooling liquid to the cooling liquid reservoir 110 for the cooling liquid of the fluid circuit 106, which, again, is intended to contain a dielectric cooling liquid. In another example, service personal may fail to recognize that the immersion cooling system 102 utilizes a dielectric cooling liquid, and thus may instead incorrectly add non-dielectric cooling liquid to the cooling liquid reservoir 110 for the cooling liquid of the fluid circuit 106.

Incompatible fluids can also be introduced into the cooling liquid and/or the fluid circuit 106 in a variety of other manners other than via the inlet 120 of the cooling liquid reservoir 110 for the cooling liquid. For example, in certain instances, non-dielectric cooling liquid in the form of water can be introduced into cooling liquid of the fluid circuit 106 of the immersion cooling system 102, such as, for example, in the form of accumulated condensation within the immersion cooling system 102, or via breaches in seals, couplings, and/or conduits 108 along the fluid circuit 106, among other manners of ingress. Further, as mentioned above, a dielectric cooling liquid of the cooling liquid can, overtime, transform into an incompatible fluid due to leaching of one or more chemicals or compositions from components of the fluid circuit 106, and/or as a consequence of a degradation of the dielectric cooling liquid, including a degradation associated with the dielectric cooling liquid beginning, and/or reaching, an end-of-life for the dielectric cooling liquid.

A variety of different types of pumps, or combinations of pumps, can be utilized for the pump 116 of the fluid circuit 106 for the immersion cooling system 102. As discussed below, at least certain types of pumps 116 can be configured to assist in isolating a detected incompatible fluid from being circulated, or flowing to, the battery 104. For example, passage of fluid through a positive displacement pump, among other types of pumps, can be at least partially dependent on an operation of a mechanical structure of the positive displacement pump. Moreover, with respect to linear displacement types of positive displacement pumps, a flow of fluid through the pump can be at least partially dependent on the linear displacement of a piston or plunger of the pump. Alternatively, with respect to rotary positive displacement pumps, the flow of fluid through the pump can be at least partially dependent on the rotational displacement of, for example, a rotary lobe, cog, or gear of the positive displacement pump. Thus, the absence of such linear or rotary displacement of such components of a positive displacement pump, such as, for example, when the positive displacement pump is in an off, or deactivated, state, can prevent the passage of cooling liquid, including cooling liquid that may contain an incompatible fluid, through the pump 116. Accordingly, for at least certain types of pumps, upon detection of a presence of an incompatible fluid within the cooling liquid and/or fluid circuit 106 by the incompatible fluid detection system 100, deactivation of the pump 116 by the incompatible fluid detection system 100 can at least assist in preventing, if not stop, incompatible fluid from flowing into at least the battery 104.

Other types of pumps, such as, for example, centrifugal pumps, among other types of pumps, can accommodate passage of fluid through the pump 116 regardless of whether the pump 116 is in an on, or activated, state, or the off state. Thus, as seen in at least FIGS. 1-4, and as discussed below, the incompatible fluid detection system 100 can include one or more valves 124, 126a-e at one or more positions about the fluid circuit 106 that can assist in isolating the incompatible fluid from flowing into the battery 104, including operating in a manner that bypasses the flow of the incompatible fluid away from the battery 104. The inclusion of such valves 124, 126a-e can be at least partially dependent, or alternatively, independent, of the type of pump(s) 116 utilized by the immersion cooling system 102.

The incompatible fluid detection system 100 can also include one or more controllers 128 having at least one processor 130 and at least one memory device 132. The controller 128, processor(s) 130, and/or memory device(s) 132 may, or may not, be dedicated to the operation of the incompatible fluid detection system 100, or components of the incompatible fluid detection system 100. Thus, for example, according to certain embodiments, the processor 130 can comprise one or more processors, including compute circuits, that can be utilized to control operation of the incompatible fluid detection system 100, and, optionally, can also be utilized in connection with controlling the operation of the immersion cooling system 102, among other components of an associate cooling system, engine, or vehicle. Therefore, according to certain embodiments, one controller 128, including one or more processors 130 of that controller 128, can be utilized to control operation of at least the incompatible fluid detection system 100, or the corresponding components of the incompatible fluid detection system 100. Alternatively, a plurality of controllers 128, or combinations of processors 130, including compute circuits, can be utilized to control operation of the incompatible fluid detection system 100, as well as control operations of different components of the immersion cooling system 102 and/or electric vehicle. Thus, for example, while certain embodiments herein may mention functions being performed by a controller 128, including the associated processor 130, such functions can be performed by a single controller or processor, or, alternatively, one or more functions can be performed by one or more controllers or processors, and one or more other functions can be performed by one or more other controllers or processors or combinations of controllers or processors.

The memory device 132 can have instructions stored therein that are executable by the processor 130 to cause the processor 130 to receive input, such as, for example, from one or more sensors 134a, 134b, 134c (generally referred to herein as sensor 134), 135, as seen in FIGS. 1-4, of the incompatible fluid detection system 100, 100a, 100b, 100c (generally referred to herein as incompatible fluid detection system 100), as well as control one or more valves 124, 126a-e of the incompatible fluid detection system 100. The processor 130 can be embodied as, or otherwise include any type of processor, controller, or other compute circuit capable of performing various tasks such as compute functions and/or controlling the functions of at least the incompatible fluid detection system 100 and/or associated components of the immersion cooling system 102. For example, the processor 130 can be embodied as a single or multi-core processor(s), a microcontroller, or other processor or processing/controlling circuit. In some embodiments, the processor 130 can be embodied as, include, or otherwise be coupled to an FPGA, an application specific integrated circuit (ASIC), reconfigurable hardware or hardware circuitry, or other specialized hardware to facilitate performance of the functions described herein. Additionally, in some embodiments, the processor 130 can be embodied as, or otherwise include a high-power processor, an accelerator co-processor, or a storage controller.

The memory device 132 can be embodied as any type of volatile (e.g., dynamic random-access memory (DRAM), etc.) or non-volatile memory capable of storing data therein. Volatile memory may be embodied as a storage medium that requires power to maintain the state of data stored by the medium. Non-limiting examples of volatile memory may include various types of random-access memory (RAM), such as dynamic random-access memory (DRAM) or static random-access memory (SRAM). One particular type of DRAM that may be used in a memory module is synchronous dynamic random-access memory (SDRAM).

In some embodiments, the memory device 132 can be embodied as a block addressable memory, such as those based on NAND or NOR technologies. The memory device 132 can also include future generation nonvolatile devices, such as a three-dimensional crosspoint memory device (e.g., Intel 3D XPoint™ memory), or other byte addressable write-in-place nonvolatile memory devices. In some embodiments, the memory device 132 can be embodied as, or may otherwise include, chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device 132 can refer to the die itself and/or to a packaged memory product. In some embodiments, 3D crosspoint memory (e.g., Intel 3D XPoint™ memory) can comprise a transistor-less stackable cross point architecture in which memory cells sit at the intersection of word lines and bit lines and are individually addressable and in which bit storage is based on a change in bulk resistance.

The sensors 134, 135 of the incompatible fluid detection system 100 can detect, including measure or provide information used to derive, one or more properties of the cooling liquid within the fluid circuit 106, among other portions of the immersion cooling system 102. Thus, the sensors 134, 135 are communicatively coupled to the controller 128 such that information, including, for example, measurements, attained by the sensors 134, 135 regarding one or more properties of the cooling liquid in at least the fluid circuit 106, or associated components thereof, can be communicated to the controller 128.

A variety of different types of sensors 134, 135 including combinations of sensors 134, 135 can be utilized by the incompatible fluid detection system 100. The number and type of sensors 134, 135 utilized by the incompatible fluid detection system 100 can vary for different incompatible fluid detection systems 100 and/or immersion cooling systems 102. Thus, for example, the incompatible fluid detection system 100 can include a single sensor 134, 135 or a plurality of sensors 134, 135. Further, the location(s) of the sensors 134, 135 can be based on a variety of criteria, including, for example, the architecture of the immersion cooling system 102, identified areas for potential ingress, or likelihood of ingress, of an incompatible fluid into the cooling liquid and/or the fluid circuit 106, and/or the environment or conditions in which the associated vehicle may operate, including, but not limited to, anticipated exposure to areas of standing water, among other considerations. In certain instances, such a determination of sensor 134, 135 location can be based on a risk assessment, including, for example, a risk assessment based on a system failure modes and effect analysis (SFMEA), among other analyses.

The sensors 134, 135 can be configured to detect a variety of different types of properties of the cooling liquid in connection with providing information the incompatible fluid detection system 100 can utilized in detecting, or not detecting, the presence of an incompatible fluid. For example, according to certain embodiments, one or more of the sensors 134, 135 can comprise a conductivity sensor, such as, for example, an electrode-type conductivity sensor, inductive conductivity sensor, and/or ultrasonic conductivity sensor, among other types of conductivity sensors. Additionally, or alternatively, one or more of the sensors 134, 135 can be configured to detect the presence of water in the fluid circuit 106, among other portions of the immersion cooling system 102. The sensor(s) 134, 135 can also be configured to detect one or other properties of the cooling liquid, including, for example, but not limited to, thermal conductivity, voltage breakdown, and/or electrical resistance, among other properties. Further, with respect to embodiments of the incompatible fluid detection system 100 that include a plurality of sensors 134, 135 one or more sensors 134, 135 may, or may not, be used to determine the same type of property of the cooling liquid as one or more other sensors 134, 135 of the incompatible fluid detection system 100. Thus, according to certain embodiments, each of a plurality of sensors 134, 135 can be configured to detect the same property of the cooling liquid, or at least some, if not all, of the sensors 134, 135 can be configured to detect a different property of the cooling liquid. Additionally, in certain instances, a plurality sensors 134, 135 that are configured to detect different properties of the cooling liquid can be located at generally the same location or area, or, alternatively, can be positioned at different locations. Such redundancy or multiplicity of sensors 134, 135 at the same, or different locations, about the fluid circuit 106 can provide further protection to the immersion cooling system 102 in the event one or more of the sensors 134, 135 fail or detect a property(ies) of portions of the cooling liquid that contains the incompatible fluid that may not, at least currently, be present in other portions of the cooling liquid.

The sensors 134, 135 can be positioned at a variety of locations about the fluid circuit 106. For example, according to certain embodiments, one or more, including a plurality, of the sensors 134, 135 can be positioned within the cooling liquid reservoir 110. Additionally, or alternatively, one or more, if not a plurality, of sensors 134 can be positioned within the cooling liquid reservoir 110, while one or more other sensors 134 can be positioned in other portions of the fluid circuit 106. According to other embodiments, the sensors 134 can be positioned at one or more locations about the fluid circuit 106 other than the cooling liquid reservoir 110. Additionally, according to other embodiments, at least one sensor 134 can be positioned at an inlet and/or outlet of, if not within a portion of, the battery 104. According to certain such embodiments, one or more sensors 134 can be part of the battery 104, including, for example, coupled to a housing of the battery 104.

According to certain embodiments, one or more sensors 134 can be positioned for in-line sensing, while one or more other bypass sensors 135 can be positioned for on-line sensing. For example, with respect to in-line sensing, one or more sensors 134 can be positioned to measure one or more properties of the fluid in, or flowing from, the cooling liquid reservoir 110 and/or battery 104, among other portions of the fluid circuit 106. With respect to on-line sensing, one or more bypass sensors 135, which may be similar to the above-discussed sensors 134, can be positioned to measure one or more properties from a portion of the portion of the fluid that is, at least temporarily, diverted from the fluid circuit 106. For example, FIG. 1 illustrates a bypass circuit 133 in which one or more valves 137a, 137b can be selectively operated to divert at least a portion of fluid to a bypass sensor 135 which can obtain measurements similar to those discussed above that can be used in connection with an identification of a presence of an incompatible fluid. Further, while FIG. 1 illustrates a single bypass circuit 133, the incompatible fluid detection system 100 can include a plurality of bypass circuits 133. Additionally, the bypass circuit(s) 133 can be positioned at a variety of locations, and, moreover, can divert fluid at one or more locations about the fluid circuit 106.

The incompatible fluid detection system 100 can also include one or more output devices 136 that are communicatively coupled to the controller 128 and utilized to provide a notification to an operator or other system, including, for example, a battery management system (BMS) of the incompatible fluid detection system 100 detecting a presence of an incompatible fluid. The type of output device 136, or combination of output devices 136, can vary. For example, one or more output devices 136 can be utilized to either, or both, provide a visual or audible notification, including alert, regarding the detection of the incompatible fluid. The output device(s) 136 can also be located at a variety of locations, including, for example, within an operator cab of the vehicle, a mobile device, or at a secondary location separate or remote from the electric vehicle, as well as combinations thereof. For example, according to certain embodiments, the electric vehicle may be an autonomous vehicle, wherein at least one output device 136 can be located at a remote location at which an operator or manager is located. Examples of mobile devices that can include the output device 136 can include, but are not limited to, a smartphone, tablet, or laptop, among other types of mobile devices. Further, the output device 136 can take a variety of forms, including, but not limited to a display 138, such as, for example, a monitor or touch screen, a speaker 140, or an illumination device, including, but not limited to a light, among other types of output devices 136.

Referencing FIG. 1, according to certain embodiments, the incompatible fluid detection system 100 can include a discharge, purge, or release valve 124 through which cooling liquid can be purged or otherwise released from the immersion cooling system 102. According to certain embodiments, the discharge valve 124 can include, or be operably coupled to, an actuator that can facilitate the discharge valve 124 automatically being displaced from an open position to a closed position in response to one or more signals generated by the controller 128. In the open position, the discharge valve 124 can accommodate a flow of the cooling liquid through the discharge valve 124 and to a downstream location(s) in the fluid circuit 106. In the closed position, the discharge valve 124 can either or both prevent the flow of cooling liquid through the discharge valve 124 and/or provide an outlet for the cooling liquid to be purged, discharged, or released, from the fluid circuit 106. For example, according to certain embodiments, upon detection of an incompatible fluid in the cooling liquid or fluid circuit 106, the controller 128 can automatically issue a signal to facilitate an operation of an actuator of the discharge valve 124 to change the discharge valve 124 from being in the open position to being in the closed position. Further, according to certain embodiments, with the discharge valve 124 in the closed position, cooling liquid within the fluid circuit 106 can be discharged or released through the discharge valve 124, including, for example, released onto an adjacent ground surface or a container or receptacle positioned beneath the discharge valve 124. Alternatively, according to other embodiments, with the discharge valve 124 in the closed position, an operator can disconnect a conduit 108 from another conduit 108, fitting, or other component, including, for example, from the discharge valve 124, so as to provide a location from which the cooling liquid can be released or purged out from the fluid circuit 106.

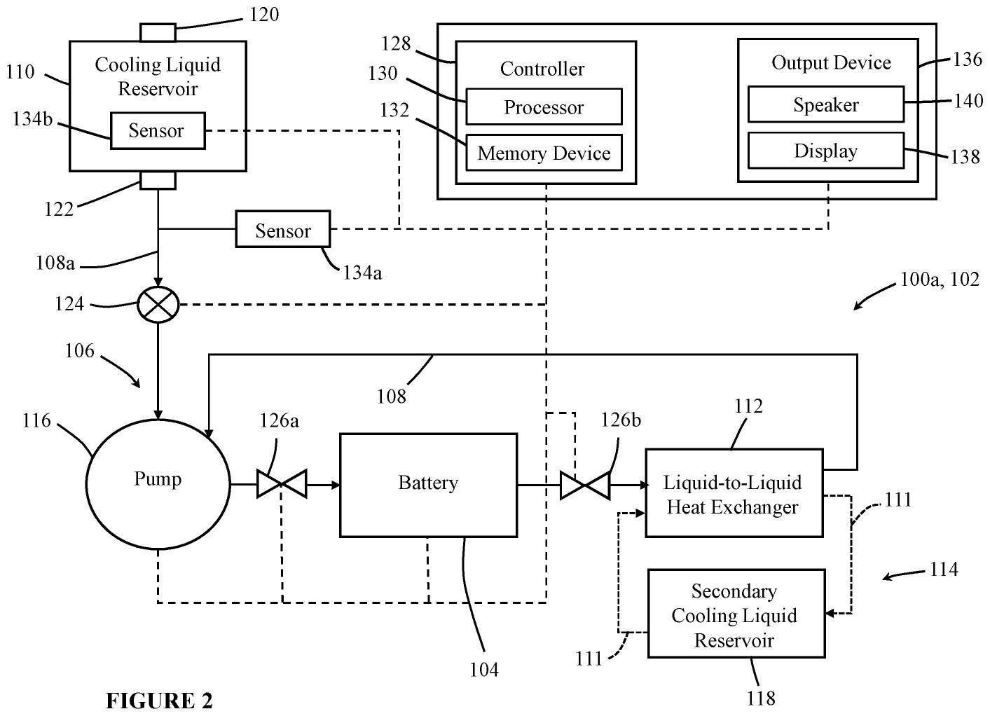

The incompatible fluid detection system 100 can also include, in addition to, or in lieu of, the discharge valve 124, one or more flow control valves 126a-e (FIGS. 2-4) that can be utilized to isolate the battery 104 from the cooling liquid, including, for example, via bypassing a flow of the cooling liquid around the battery 104. A variety of different types of valves, or combination of valves, can be utilized for the flow control valves 126a-e, including, but not limited to, mechanical valves, electric on/off valves, solenoid valves, pressure check valves, proportional valves, and/or multi-port or multi-way valves, as well as combinations thereof, among other types of valves. In the illustrated embodiment, one or more, if not all, of the valves 126a-e can be communicatively coupled to the controller 128 such that the controller 128 can generate one or more signals to control whether the valves 126a-e are in an open position or a closed position, or a position therebetween. Further, for each valve 126a-e, whether the valve 126a-e is in an open position or closed position can be at least partially dependent on whether the information from the sensor(s) 134, 135 indicate, or do not indicate, the presence of an incompatible fluid in the cooling liquid and/or fluid circuit 106.

The valves 126a-e can be operated to at least attempt to isolate the detected incompatible fluid from entering into the battery 104. Additionally, according to certain embodiments, such valves 126a-e can also be utilized in at least an attempt to isolate portions of the fluid circuit 106 having the incompatible fluid from other portions of the fluid circuit 106 in which the incompatible fluid has not been detected. By isolating each of those other portions of the fluid circuit 106 from the detected incompatible fluid, those non-contaminated portions of the fluid circuit 106 may not need to be replaced, or otherwise cleaned and/or purged to the same extent as other, portions of the fluid circuit 106 that have been contaminated by incompatible fluid.

Referencing FIGS. 1-4, according to certain embodiments, the incompatible fluid detection system 100, 100a, 100b, 100c can be a normally open system or a normally closed system. With respect to a normally open system, one or more valves 124, 126a-e are, by default, to be in the open position so as to allow passage of cooling liquid through the open valve 124, 126a-e. Moreover, by being defaulted to the open position, the opened valves 124, 126a-e can accommodate a flow of cooling liquid through the opened valve 124, 126a-e such that the cooling liquid flows along a flow path in which the cooling liquid is circulated to the battery 104. According to such an embodiment, one or more of the valves 124, 126a-e can, by default, be configured to remain in the open position until the incompatible fluid detection system 100 detects the presence of an incompatible fluid in, or which otherwise comprises, the cooling liquid. Moreover, for example, in response to a sensor 134, 135 providing information to the controller 128 indicating such a presence of incompatible fluid in the fluid circuit 106, the controller 128 can generate one or more signals to facilitate a closing of one or more open valves 124, 126a-e so as to isolate the battery 104 from the incompatible fluid.

Which opened valves 124, 126a-e are, or are not, to be closed in response to a detection of an incompatible fluid can vary. For example, according to certain embodiments, in response to a detection by the incompatible fluid detection system 100 of a presence of an incompatible fluid anywhere in the fluid circuit 106, each opened valve 124, 126a-e of the incompatible fluid detection system 100 can be closed so as to isolate the battery 104, as well as to at least attempt to prevent, or limit, other portions of the fluid circuit 106 from being contaminated by the incompatible fluid. Alternatively, according to certain embodiments, only the opened valves 124, 126a-e that can isolate the contaminated portion of the fluid circuit 106 may be closed, while other valves 124, 126a-e associated with other regions of the fluid circuit 106 in which a presence of incompatible fluid has not been detected may remain open. Further, as discussed below, with respect to multi-way valves, such as, for example three-way valves, a position of the valve 124, 126a-e can be adjusted so as to close a flow path for the cooling liquid to the battery 104, and instead open a flow path in which the cooling liquid bypasses the battery 104.

With respect to embodiments in which the incompatible fluid detection system 100 is a normally closed system, one or more valves 124, 126a-e of the incompatible fluid detection system 100 can be configured to, by default, be in the closed position. In the closed position, the closed valve 124, 126a-e can prevent cooling liquid from flowing through the closed valve 124, 126a-e, or otherwise prevent cooling liquid that passes through the closed valve 124, 126a-e from flowing along a flow path wherein the cooling liquid could be circulated to the battery 104. With such an embodiment, the valves 124, 126a-e that are to be, by default, in the closed position, can remain closed until the incompatible fluid detection system 100 determines there is an absence of a detection or presence of incompatible fluid in the fluid circuit 106. Moreover, in response to the controller 128 determining, based on information provided by the sensors 134, 135 that an incompatible fluid is not present in the fluid circuit 106, the valves 124, 126a-e that by default are to be in the closed position can be opened. Additionally, according to certain embodiments, the controller 128 can be configured to generally continuously determine that incompatible fluid is not detected in the fluid circuit 106 in order for the valves 124, 126a-e remain open. Accordingly, during typical operation of the immersion cooling system 102 in which the fluid circuit 106 is not contaminated by an incompatible fluid, the valves 124, 126a-e that are, by default, to be in the closed position, can be maintained in an open position by continued determination by the controller 128, and associated signals to the valves 124, 126a-e, of an absence of detection of incompatible fluid so as to accommodate the immersion cooling system 102 circulating the cooling liquid to, and through, the battery 104. However, in the event the controller 128 fails to determine, or communicate a signal to the valves 124, 126a-e that are by default to be in the closed position, that there is an absence of a detection of an incompatible fluid in the fluid circuit 106, such opened valves 124, 126a-e can, by default, be placed in the closed position.

According to certain embodiments in which the incompatible fluid detection system 100 is a normally closed system, which, if not all, valves 124, 126a-e that are, by default, to be in the closed position can be based on a variety of criteria, including, but not limited to, the architecture of the fluid circuit 106. For example, according to certain embodiments, the valves that are, by default, to be in the closed position may be one or more valves 124, 126a-e at, or near, locations or areas that are identified to have higher risks than other areas of the fluid circuit 106 for an ingress of an incompatible fluid into cooling liquid or fluid circuit 106. For example, as discussed above, one potential area of risk for an ingress of an incompatible fluid is the inlet 120 of the cooling liquid reservoir 110. Thus, according to certain embodiments, a valve 124, 126a-e that is, by default, to be in the closed position, can be position at a location at, or relatively close, to the outlet 122 of the cooling liquid reservoir 110. Thus, in such an example, the controller 128 may confirm, and continuously confirm, the absence of incompatible fluid in, or passing through the outlet 122 of, the cooling liquid reservoir 110, before the valve 124, 126c near the outlet 122 of the cooling liquid reservoir 110 will accommodate passage of the cooling liquid to other, downstream locations of the fluid circuit 106.

With respect to valves 124, 126a-e that are multi-port or multi-way valves (collectively referred to herein as multi-way valves), such as, for example, three-way valves, when in the normally open position, the multi-way valve directs the cooling liquid through the multi-way valve such that the cooling liquid flows along a path that circulates the cooling liquid to the battery 104. As discussed below, such multi-way valves can have one or more secondary open positions wherein the multi-way valves divert the flow of the cooling liquid to a bypass circuit, or other conduits or circuits that are configured to direct the flow of the cooling liquid along a flow path that does not include, or is not fluidly coupled to, at least the battery 104. Thus, such multi-way valves can be utilized to isolate the battery 104 from a flow of incompatible fluid by directing the flow of the incompatible fluid along another flow path.

FIG. 1 illustrates an exemplary embodiment of an incompatible fluid detection system 100 in which a first sensor 134a is positioned to detect the presence of an incompatible fluid that has been added to the cooling liquid reservoir 110. While the first sensor 134a is illustrated in FIG. 1 as being adjacent to, and downstream of, the cooling liquid reservoir 110, according to certain embodiments another, second sensor 134b, can be positioned within the cooling liquid reservoir 110, as previously discussed and as seen in FIG. 2. Thus, according to the exemplary embodiments shown in FIGS. 1 and 2, the first sensor 134a and/or second sensor 134b can provide information to the controller 128 that the controller 128 can use detect the presence of the incompatible fluid within of the cooling liquid reservoir 110 and/or at, or around, the outlet 122 of the cooling liquid reservoir 110. With such an embodiment, in response to the detection of the incompatible fluid, according to embodiments in which the incompatible fluid detection system 100 is a normally open system, the controller 128 can generate one or more signals to facilitate the closure of the discharge valve 124 so as to prevent, or limit, the extent, the detected incompatible fluid can flow downstream of the cooling liquid reservoir 110, and moreover, at least attempt to prevent the incompatible fluid from being circulated to at least the battery 104. Alternatively, according to embodiments in which the incompatible fluid detection system 100 is a normally closed system, the controller 128 may not generate a signal to open the discharge valve 124, which, according to such embodiment, may, by default, result in the discharge valve 124 being, by default, placed in the closed position, as discussed above.

Additionally, according to certain embodiments, the discharge valve 124 illustrated in FIG. 1 can be configured to, when in the closed position, cause the cooling liquid, including the incompatible fluid, located upstream of the discharge valve 124, to be automatically discharged or purged from the fluid circuit 106. Such discharge of the cooling liquid, including the incompatible fluid, from the fluid circuit 106 can be directly through the discharge valve 124, or, alternatively, through other conduit that can be fluidly coupled to the discharge valve 124.

In addition to, or in lieu of the discharge valve 124, or other type of valve, as shown in FIG. 1, the pump 116 can also be configured to prevent a flow of cooling liquid, including incompatible fluid contained therein, to the battery 104, as previously discussed. For example, as previously discussed, with respect to embodiments in which the pump 116 is a positive displacement pump 116, among other types of pumps, deactivation of the pump 116 via one or more control signals from the controller 128 in response to the detection of the incompatible fluid can be utilized to prevent the flow of incompatible fluid through the pump 116, thereby isolating the battery 104 from Incompatible fluid that is located upstream of the pump 116.

Referencing the exemplary embodiment of an incompatible fluid detection system 100a shown in FIG. 2, the incompatible fluid detection system 100a shown in FIG. 2 is similar to the incompatible fluid detection system 100 shown in FIG. 1, but further includes the second sensor 134b, an inlet valve 126a, and an outlet valve 126b. Thus, the embodiment shown in FIG. 2 can be at least operated in a manner similar to that discussed above with respect to FIG. 1, as well as also operated to isolate the battery 104 via operation of the inlet and outlet valves 126a, 126b.

For example, as discussed above, similar to the incompatible fluid detection system 100 discussed above with respect to FIG. 1, upon detection by the controller 128 of a presence of incompatible fluid in the fluid circuit 106, the controller 128 of the incompatible fluid detection system 100a shown in FIG. 2 can, for a normally open system, generate one or more signals to have the discharge valve 124 be placed in the closed position. Alternatively, for a normally closed system, as discussed above, upon detection of the incompatible fluid, the controller 128 may not generate a signal for the discharge valve 124 so that, by default, the discharge valve 124, by default, returns to the closed position. Additionally, or alternatively, as also discussed above, the controller 128 can deactivate the pump 116.

In addition to, or in lieu of, the above-discussed actions with respect to the discharge valve 124 and pump 116, the controller 128 for the incompatible fluid detection system 100a shown in FIG. 2 can generate one or more signals to close the inlet valve 126a and the outlet valve 126b. Alternatively, according to embodiments in which the incompatible fluid detection system 100a is a normally closed system, the controller 128 may not issue any signal to have the inlet and outlet valves 126a, 126b return to closed positions. Thus, with the inlet and outlet valves 126a, 126b in the closed positions, the battery 104 can be isolated from the detected incompatible fluid. Further, placement of the inlet and outlet valves 126a, 126b adjacent to corresponding inlet 120 and outlet 122 of the battery 104 can, in addition to further assisting in isolating the battery 104 from incompatible fluid, also facilitate the ease at which the battery 104 can be removed from the immersion cooling system, including, with respect to replacement of the battery 104.

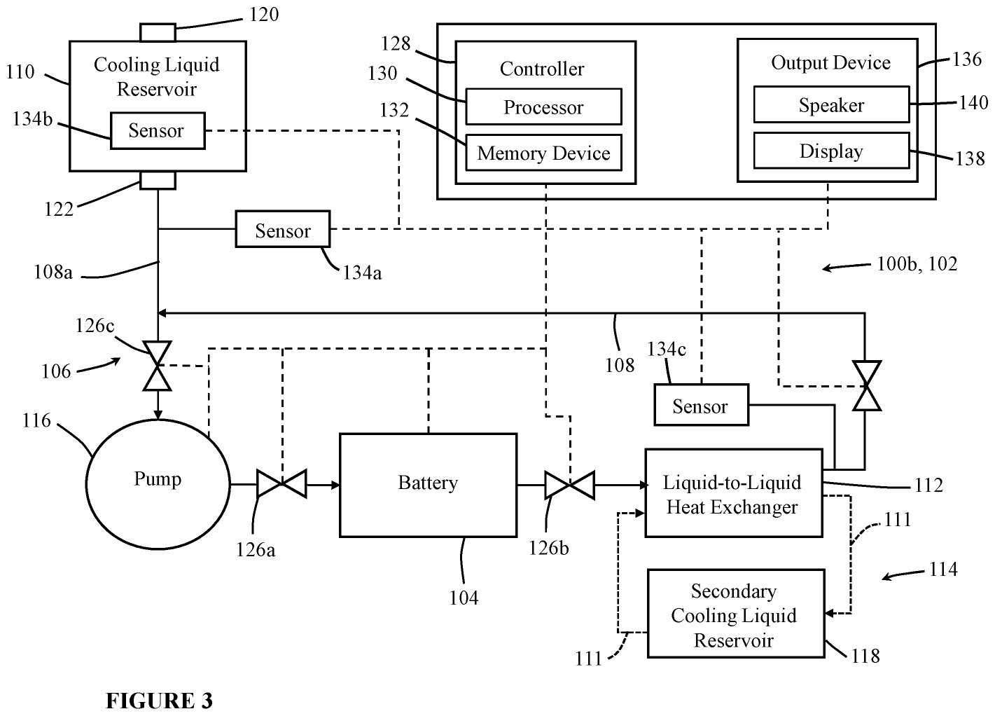

Turning to the exemplary embodiment of an incompatible fluid detection system 100b illustrated in FIG. 3, in addition to, or in lieu of, the discharge valve 124, a first, upstream valve 126c is positioned upstream of an inlet to the pump 116. According to such an embodiment, one or both of the cooling liquid flowing from the cooling liquid reservoir 110, and cooling liquid that is being recirculated from at least the battery 104, can pass through the inlet valve 126a before entering at least the pump 116. Accordingly, similar to the discharge valve 124 shown in FIG. 1, the first, upstream valve 126c shown in FIG. 3 can prevent incompatible fluid that has entered into the cooling liquid and or fluid circuit 106 via the cooling liquid reservoir 110 from flowing to other, downstream components of the fluid circuit 106, including, for example, at least the pump 116 and battery 104. The incompatible fluid detection system 100b shown in FIG. 3 also includes the inlet and outlet valves 126a, 126b discussed above with respect to FIG. 3.

The incompatible fluid detection system 100b shown in FIG. 3 further includes a third sensor 134c position downstream of the heat exchanger 112. As previously discussed, according to certain embodiments, the heat exchanger 112 can be a liquid-to-liquid type of heat exchanger 112 such that the heat exchanger 112 can provide an area for potential ingress into the fluid circuit 106 of incompatible fluid in the form of at least secondary cooling liquid from the secondary circuit 114. Thus, in this example, in the event incompatible fluid in the form of the secondary cooling liquid enters into the fluid circuit 106 at or around the heat exchanger 112, the presence of such incompatible fluid can be detected by one or more signals provided by the third sensor 134c to the controller 128. In response to the controller 128 determining a presence of incompatible liquid in the cooling liquid and/or fluid circuit 106 from information provided by the third sensor 134c, the controller 128 can issue one or more signals that can facilitate a closure of a second, downstream valve 126d that can be positioned downstream of the liquid-to-liquid heat exchanger 112, including, for example at or around an outlet of the liquid-to-liquid heat exchanger 112. Moreover the second, downstream valve 126d can be positioned at a location between the liquid-to-liquid heat exchanger 112 and other components of the fluid circuit 106, including, for example, the pump 116, among other components, so as to minimize the portion of the fluid circuit 106 that may be contaminated by the presence of the incompatible fluid. Further, according to embodiments in which the incompatible fluid detection system 100b is a normally closed system, in response to the controller 128 detecting the presence of an incompatible fluid from information provided by the third sensor 134c, the controller 128 can cease providing signals to the second, downstream valve 126d such that the second, downstream valve 126d returns to its default closed position.

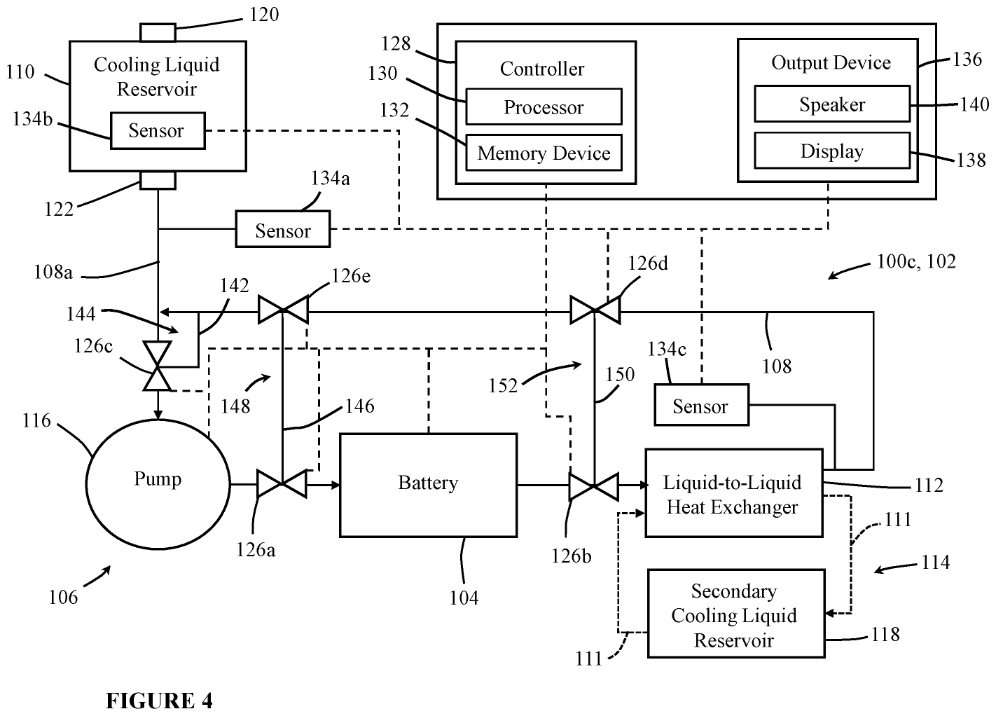

According to certain embodiments discussed herein in which the incompatible fluid detection system 100b includes a plurality of sensors 134a, 134b, 134c, a determination by the controller 128 of a presence of an incompatible fluid via information provided by one sensor 134a, 134b, 134c can facilitate and opening or closing, as well as combination thereof, of a plurality of valves 124, 126a-e of the incompatible fluid detection system 100b. For example, in response to the controller 128 determining a presence of an incompatible fluid using information from the third sensor 134c, the controller 128 can issue one or more signals to facilitate a closure of the second, downstream valve 126d, as well as a closure of one or more, if not all, of the first, upstream valve 126c, inlet valve 126a, or outlet valve 126b, as well as any combination thereof. Thus, in this example, while the presence of the incompatible fluid may be detected at a location downstream of the battery 104, and such incompatible fluid may be isolated from the battery 104 via the closure of the second, downstream valve 126d, other valves 124, 126a, 126b, 126c, 126e may also be closed so as to ensure that the battery 104 is isolated from any incompatible fluid in the fluid circuit 106. Additionally, or alternatively, as discussed below, the fluid circuit 106 can include one or more bypass circuits 144, 148, 152 (FIG. 4) such that cooling liquid that has not been detected to include, or comprise, an incompatible fluid can continue to be circulated to the battery 104 to at least assist in maintaining, or reducing, the temperature of the battery 104, including battery 104 cells, at least until the temperature of the battery 104 is reduced to a level at which stoppage of the flow of cooling liquid to the battery 104 may cause limited, if any, damage to the battery 104.

FIG. 4 illustrates a fourth embodiment of an exemplary incompatible fluid detection system 100c in which one or more valves 126a-e are multi-way valves that can be utilized to divert cooling liquid a bypass circuit 144, 148, 152 such that the battery 104 is isolated from cooling liquid comprising, or containing, incompatible fluid. For example, in the embodiment illustrated in FIG. 4, the first, upstream valve 126c can be at least a three-way valve that, when placed in a secondary open position, such as, for example, in response to a receipt of a signal from the controller 128 relating to a detection of an incompatible fluid from information provided by one or more sensors 134a, 134b, 134c, can divert a flow of cooling liquid to a first, bypass conduit 142 of a first bypass circuit 144. According to certain embodiments, the first bypass conduit 142 can, be part of a redirection of the cooling liquid such that the cooling liquid is diverted from the first, upstream valve 126c and directly or indirectly to a supply conduit 108a that is positioned between the cooling liquid reservoir 110 and the first, upstream valve 126c. Additionally, according to such an embodiment, one or more other valves 126e of the incompatible fluid detection system 100c can be closed so as to prevent back flow of the incompatible fluid through the fluid circuit 106.

Additionally, or alternatively, according to certain embodiments, the inlet valve 126a can be a multi-way valve that can be part of another, or second, bypass circuit 148. Thus, for example, in response to a detection of an incompatible, cooling liquid that has passed through the pump 116 can be diverted by the inlet valve 126a to a second bypass conduit 146 of the second bypass circuit 148. In the illustrated embodiment, the second bypass circuit 148 can recirculate cooling liquid to a location at which the cooling liquid can again passes through, and/or is pumped by, the pump 116. Additionally, according to the embodiment shown in FIG. 4, the second bypass conduit 146 can be fluidly coupled to a third, downstream valve 126e, which can also be a multi-way valve that can assist in redirecting the diverted cooling liquid back to the supply conduit 108a, and or, other location upstream of the pump 116.

FIG. 4 also illustrates and additional, or optional, third bypass circuit 152 in which a third bypass conduit 150 extends between the outlet valve 126b that is at or downstream of the outlet of the battery 104, and the second, downstream valve 126d. According to such an embodiment, the third bypass circuit 152 can be figured to isolate at least cooling liquid that has passed through the heat exchanger 112 from being recirculated to the pump 116, and thus from being circulated to the battery 104. Moreover, the third bypass circuit 152 can be configured to isolate cooling liquid downstream of the battery 104. For example, according to the illustrated embodiment, the outlet valve 126b and the second, downstream valve 126d can each be a multi-way valve. In the event the third sensor 134c provides information from which the controller 128 determines a presence of incompatible fluid in the fluid circuit 106, such as, for example, secondary cooling liquid that has entered the cooling liquid at or around the heat exchanger 112, the controller 128 can generate one or more signals to cause the outlet valve 126b and the second, downstream valve 126d to each be placed in secondary open positions. With the valves 126b, 126d in the secondary open positions, the second, downstream valve 126d can assist in the cooling liquid, including the incompatible fluid, that has passed through the heat exchanger 112 being diverted via the third bypass conduit 150 back to the outlet valve 126b, and subsequently flowing again to the heat exchanger 112, thereby isolating the battery 104 and other portions of the fluid circuit 106 from the incompatible fluid. Alternatively, according to certain embodiments, in response to detection of an incompatible fluid in other portions of the fluid circuit 106, the controller 128 can place the outlet valve 126b and second, downstream valve 126d in the secondary position such that the incompatible fluid does not enter into at least the heat exchanger 112. Such isolation of the heat exchanger 112, among other components of the immersion cooling system located about the third bypass circuit 152, from the incompatible liquid can lessen the likelihood of the heat exchanger 112 having to undergo thorough cleaning, or even replacement, to ensure complete removal of the incompatible fluid, or associated residue, from the heat exchanger 112.

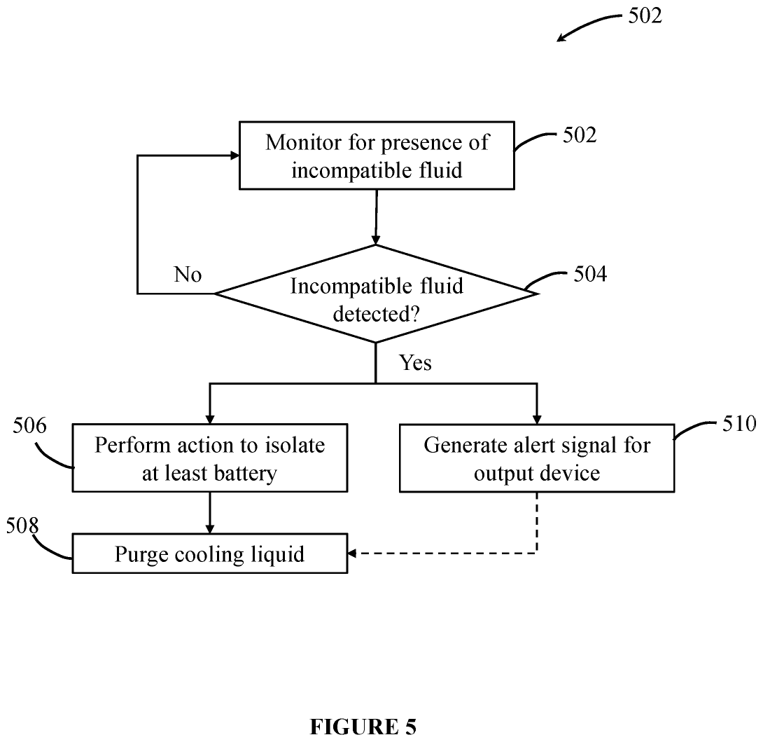

FIG. 5 illustrates an exemplary method 500 for operating an incompatible fluid detection system 100 for one or more immersion cooled batteries 104 of an electric vehicle. The method 500 is described below in the context of being carried out by the illustrated exemplary incompatible fluid detection system 100. However, it should be appreciated that method 500 can likewise be carried out by any of the other described implementations, as well as variations thereof. Further, the method 500 corresponds to, or is otherwise associated with, performance of the blocks described below in the illustrative sequence of FIG. 5. It should be appreciated, however, that the method 500 can be performed in one or more sequences different from the illustrative sequence. Additionally, one or more of the blocks mentioned below may not be performed, and the method 500 can include steps or processes other than those discussed below.

At block 502, the controller 128 can utilize information provided by one or more sensors 134, 135 in connection with determining whether an incompatible fluid is detected within the fluid circuit 106. As previously mentioned, according to certain embodiments, the presence of an incompatible fluid in the fluid circuit 106 can in certain instances, not be attributed to the ingress of a non-dielectric liquid into the fluid circuit 106, but instead attributed to existing dielectric cooling liquid degrading, including, for example, reaching an end-of-life, or otherwise being contaminated, such as, for example, via leaching, of chemicals into the cooling liquid from components of the fluid circuit 106. With respect to end-of-life, one or more properties of the cooling liquid can be measured and evaluated, for example, via use of an algorithm and/or relative to a corresponding threshold, which can be a range, that can provide an indication that the usefulness or effectiveness, among other properties or characteristics of the cooling liquid. Moreover, such analysis by an algorithm, or corresponding predetermined thresholds, can indicate the cooling liquid has degraded, including, been broken down, to a level indicating the cooling liquid has begun, or reached, its end-of-life.

Using at least the information provided by one or more sensors 134, 135, the controller 128 can determine at block 504 whether an incompatible fluid is, or is not, present in the fluid circuit 106. If the controller 128 determines at block 504 that an incompatible fluid is not present in the fluid circuit, the controller 128 can resume with monitoring for the presence of an incompatible fluid at block 502. Additionally, as previously discussed, according to certain embodiments in which one or more valves 124, 126a-e of the incompatible fluid detection system 100 are, by default, to be in the closed position, in response to a determination, or continued determination, by the controller 128 that incompatible fluid is not present in the fluid circuit 106, the controller 128 can generate one or more signals to open, and/or retain open, those valves 124, 126a-e.

In the event the controller 128 determines at block 504 that an incompatible fluid is detected in the fluid circuit 106, then at block 506 the controller 128 can generate one or more commands to perform certain actions to at least isolate the battery 104 from the detected incompatible fluid. The type, and number of actions, taken by the controller 128 can be at least partially dependent on the architecture of the immersion cooling system 102 and/or fluid circuit 106, and/or the location at which the incompatible fluid is detected. For example, as previously discussed, with respect to certain types of pumps 116, deactivation of the pump 116 can prevent a flow of upstream cooling liquid through the pump 116, which can assist in isolating the battery 104 from an incompatible fluid. However, as also previously discussed, other types of pumps, including, for example, centrifugal pumps, can accommodate a flow of cooling liquid through the pump 116, regardless of the pump 116 being deactivated or in an off state.

The actions taken at block 504 can, according to certain embodiments, include closing one or more valves 124, 126a-e of the incompatible fluid detection system 100. As discussed with respect to at least FIGS. 1-4, one or more valves 124, 126a-e, including, but not limited to, a discharge valve 124, can, to the extent the valves 124, 126a-e are open, be closed in response to one or more signals from the controller 128. Additionally, as previously discussed, such closing of valves 124, 126a-e may be utilized to not only attempt to isolate the battery 104 from exposure to the incompatible fluid, but can also isolate other components of the immersion cooling system 102 from being contaminated by the incompatible fluid. Further, as also previously discussed, according to certain embodiments, such isolation of the battery 104, or other components, of the immersion cooling system 102 from be incompatible fluid can involve bypassing a flow of cooling liquid d along one or more bypass circuits 144, 148, 152. Additionally, according to certain embodiments, the controller 128 of the incompatible fluid detection system 100 can determine whether one or more valves 124, 126a-e can be closed any manner that can isolate the incompatible fluid from the battery 104 while other valves 124, 126a-e can remain open such that cooling liquid that has not been detected as having, or comprising, incompatible fluid can be diverted, at least temporarily, as to further reduce temperature of the battery 104, and moreover, of the battery cells contained therein, to a level that may minimize, or prevent, damage to the battery 104 that could otherwise be associated with a sudden stoppage of a supply of cooling liquid to the battery 104.

Additionally, according to certain embodiments, the controller 128 can also be configured to, in response to detection of the incompatible fluid, automatically perform one or more operations to facilitate a discharge, or purging, of at least the incompatible fluid from the fluid circuit 106. For example, as previously discussed, in response to detection of an incompatible fluid, the controller 128 can generate one or more signals to a discharge valve 124 that can result in the discharge valve 124 being placed in a position at which at least the incompatible fluid is discharged, or otherwise released, from the fluid circuit 106.

As also seen in FIG. 5, in response to the detection of an incompatible fluid at block 504, the controller can, at block 510, generate one or more signals to facilitate an outputting of an alert signal via the output device 136. Although FIG. 5 illustrates generation of the notification via the output device 136 at block 510 being in parallel with the previously discussed action at block 506, one of the steps associated with blocks 506 and 510 and be performed in succession, with the step associate with block 506 occurring before the step associated with block 510, or vice versa. As previously discussed, the notification provided by operation of the output device 136 can be in the form of a visual, audible, or haptic notification to an operator, as well as any combination thereof.

While FIG. 5 provides an example in which purging of the cooling liquid automatically occurs at block 508, according to other embodiments, such purging of cooling liquid can be performed manually. Moreover, as indicated by the broken line in FIG. 5, according to certain embodiments, in response to notification to the operator at block 510 of the detection of the incompatible fluid, the operator can manually purge or discharge the cooling liquid, including at least the incompatible fluid. For example, the operator can open a coupling, fitting, conduit 108, or discharge valve so as to drain cooling liquid from the fluid circuit 106. Additionally, according to embodiments in which the operator is to purge the cooling liquid from the fluid circuit 106 in response to being notified of the detection of the incompatible fluid, the actions taken at block 506 can include actions to prevent the operator from further utilizing the electric vehicle until the presence of the incompatible fluid in the fluid circuit 106 is resolved, and, moreover, eliminated. For example, according to certain embodiments, the actions at block 506 can further include an automatic deactivation, or turning off, of the associated electric vehicle motor or engine, or one or more systems of the electric vehicle, with no advance warning, or, alternatively, within a certain predetermined time limit so as to prevent the battery 104 from being overheated due to a stoppage of a circulation of cooling liquid to at least the battery 104.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An immersion cooling system for cooling a battery and having an incompatible fluid detection system, the immersion cooling system:
a fluid circuit configured to circulate a cooling liquid to the battery;
a plurality of sensors configured to sense one or more properties of at least the cooling liquid, a first sensor of the plurality of sensors positioned within a cooling liquid reservoir of the immersion cooling system;
at least one processor; and
a memory device coupled to the at least one processor, the memory device including instructions that when executed by the at least one processor cause one or more of the at least one processor to:
determine, based on at least information provided by the plurality of sensors, a presence of an incompatible fluid in the fluid circuit, and
generate, in response to the determination of the presence of the incompatible fluid, one or more signals to facilitate an adjustment of a flow path of the incompatible fluid within the fluid circuit to isolate the battery from the incompatible fluid.

2. The immersion cooling system of claim 1, wherein the at least one sensor of the plurality of sensors is configured to measure an electrical conductivity of the cooling liquid.

3. The immersion cooling system of claim 1, wherein the plurality of sensors includes a second sensor positioned within the cooling liquid reservoir.

4. The immersion cooling system of claim 1, wherein the plurality of sensors includes a second sensor positioned downstream of an outlet of the cooling liquid reservoir.

5. The immersion cooling system of claim 4, wherein the one or more signals generated by the processor at least deactivates a pump of the immersion cooling system, the pump being configured to prevent a flow of the incompatible fluid through the pump when the pump is deactivated.

6. The immersion cooling system of claim 1, wherein the one or more signals generated by the processor at least closes a valve positioned along the fluid circuit.

7. The immersion cooling system of claim 1, wherein the memory device further includes instructions that when executed by the at least one processor cause one or more of the at least one processor to generate one or more signals to place at least one discharge valve in a closed position, and, wherein at the closed position, the discharge valve is configured to discharge at least the incompatible fluid from the fluid circuit, and wherein the plurality of sensors includes at least one bypass sensor positioned along a bypass circuit.

8. The immersion cooling system of claim 1, wherein the memory device further includes instructions that when executed by the at least one processor cause one or more of the at least one processor to generate one or more signals for an output device to output a notification of the determination of the presence of the incompatible fluid, wherein the notification comprises at least one of a visual alert, an audible alert, and a haptic alert.

9. The immersion cooling system of claim 1, wherein the one or more signals generated by the processor changes at least one valve from being in an open position to being in a secondary open position, wherein, at the secondary open position, the at least one valve diverts the incompatible fluid to at least one bypass circuit.

10. The immersion cooling system of claim 1, wherein the memory device further includes instructions that when executed by the at least one processor cause one or more of the at least one processor to determine, using at least information provided by at least one sensor of the plurality of sensors, whether the cooling liquid satisfies an end-of-life threshold for the cooling liquid, and wherein the at least one processor determines the presence of the incompatible fluid based on the determination that the cooling liquid satisfies the end-of-life threshold.

11. An immersion cooling system for cooling a battery and having an incompatible fluid detection system, the immersion cooling system comprising:
a fluid circuit configured to circulate a cooling liquid to the battery;
at least one processor; and
a memory device coupled to the at least one processor, the memory device including instructions that when executed by the at least one processor cause one or more of the at least one processor to:
determine a presence of an incompatible fluid in the fluid circuit, and
generate, in response to the determination of the presence of the incompatible fluid, one or more signals to facilitate an adjustment of a flow path of the incompatible fluid within the fluid circuit to isolate the battery from the incompatible fluid.

12. The immersion cooling system of claim 11, wherein the memory device further includes instructions that when executed by the at least one processor cause one or more of the at least one processor to determine, using information of one or more monitored properties of either or both the cooling liquid or the incompatible fluid, the presence of the incompatible fluid in the fluid circuit.

13. The immersion cooling system of claim 11, wherein the memory device further includes instructions that when executed by the at least one processor cause one or more of the at least one processor to:
determine, using at least information provided by one or more measured properties of the cooling liquid, whether the cooling liquid satisfies an end-of-life threshold for the cooling liquid,
wherein the at least one processor determines the presence of the incompatible fluid based on the determination that the cooling liquid satisfies the end-of-life threshold.

14. The immersion cooling system of claim 11, wherein the one or more signals generated by the processor facilitates at least one of the following: (1) a closure of at least one valve positioned along the fluid circuit, (2) a deactivation of a pump of the immersion cooling system, the pump being configured to prevent a flow of the incompatible fluid through the pump when the pump is deactivated, or (3) an adjustment of at least one valve from being in an open position to being in a secondary open position, wherein, at the secondary open position, the at least one valve diverts the incompatible fluid to at least one bypass circuit.

15. The immersion cooling system of claim 11, wherein the memory device further includes instructions that when executed by the at least one processor cause one or more of the at least one processor to generate one or more signals for an output device to output a notification of the determination of the presence of the incompatible fluid, wherein the notification comprises at least one of a visual alert, an audible alert, and a haptic alert.

16. A method for detecting a presence of an incompatible fluid within a fluid circuit of an immersion cooling system for a battery of an electric vehicle, the method comprising:
monitoring, by a plurality of sensors, one or more properties of a fluid within the fluid circuit, at least one of the plurality of sensors being positioned within a cooling liquid reservoir of the immersion cooling system;
detecting, using at least information from the monitored one or more properties, at least a portion of the fluid in the fluid circuit comprises an incompatible fluid; and
generating, in response to the detection of the incompatible fluid, one or more signals to facilitate an adjustment of a flow path of at least the incompatible fluid within the fluid circuit to isolate the battery from the incompatible fluid.

17. The method of claim 16, wherein monitoring the one or more properties of the fluid comprises monitoring, using at least information from a first sensor and a second sensor of the plurality of sensors, the one or more properties of the fluid within the fluid circuit, the first and second sensors being positioned within the cooling liquid reservoir.

18. The method of claim 16, wherein the one or more signals facilitates at least one of the following: (1) a closure of at least one valve positioned along the fluid circuit, (2) a deactivation of a pump of the immersion cooling system, the pump being configured to prevent a flow of the incompatible fluid through the pump when the pump is deactivated, or (3) an adjustment of at least one valve from being in an open position to being in a secondary open position, wherein, at the secondary open position, the at least one valve diverts the incompatible fluid to at least one bypass circuit.

19. The method of claim 16, further comprising determining, using at least the monitored one or more properties, whether the fluid satisfies an end-of-life threshold for the fluid,
and wherein the detecting at least a portion of the fluid comprises an incompatible fluid comprises determining the fluid satisfies an end-of-life threshold.

20. The method of claim 16, further comprising generating one or more signals for an output device to output a notification of the detection of the incompatible fluid, wherein the notification comprises at least one of a visual alert, an audible alert, and a haptic alert.
